(19) United States
(12) Patent Application Publication
(10) Pub. No.: US 2023/0366558 A1
(43) Pub. Date: Nov. 16, 2023

(54) PORTABLE COMBINATION STOVE AND SPACE HEATER

(71) Applicant: InstaFire, LLC, Ogden, UT (US)

(72) Inventors: Garold H. Williams, Logan, UT (US); Konel S. Banner, Ogden, UT (US)

(21) Appl. No.: 17/742,083

(22) Filed: May 11, 2022

(51) Int. Cl. F24C 15/00; F24H 3/04; F24C 1/16; F01N 5/02

(52) U.S. Cl. CPC F24C 15/006; F24H 3/0417; F24C 15/001; F24C 1/16; F01N 5/025; F24H 2250/00; F05D 2220/60; F05D 2220/76

(57) ABSTRACT

A combination stove and space heater is provided, comprising a stove portion and a removable heater portion disposed over the stove portion. The stove portion includes an enclosure having a removable drawer configured to receive one or more burnable fuels, a grating suspended by the enclosure over the removable drawer and configured to be heated by burning the one or more fuels. The removable heater portion includes a radiator having a plurality of vertical plates, each having a length along a lateral axis and a height along a vertical axis, an axial fan disposed at one side of the radiator and with an axis of flow substantially parallel to the lateral axis, and a cover disposed surrounding the radiator and the axial fan, the cover having openings on opposing ends along the lateral axis.

### TECHNICAL FIELD

The present disclosure relates to heating devices, and more particularly relates to a portable combination stove and space heater.

### BRIEF DESCRIPTION OF THE DRAWINGS

FIG. 1 is a simplified perspective view of an exemplary combination stove and space heater in accordance with one embodiment of the present disclosure.

FIG. 2 is a simplified exploded perspective view of an exemplary combination stove and space heater in accordance with one embodiment of the present disclosure.

FIG. 3 is a simplified exploded partial perspective view of components of an exemplary combination stove and space heater in accordance with one embodiment of the present disclosure.

FIG. 4 is a simplified exploded partial perspective view of components of an exemplary combination stove and space heater in accordance with one embodiment of the present disclosure.

FIG. 5 is a simplified exploded partial perspective view of components of an exemplary combination stove and space heater in accordance with one embodiment of the present disclosure.

FIG. 6 is a simplified partial perspective view of a fan assembly of an exemplary combination stove and space heater in accordance with one embodiment of the present disclosure.

FIG. 7 is a simplified partial perspective view of a fan assembly of an exemplary combination stove and space heater in accordance with one embodiment of the present disclosure.

### DETAILED DESCRIPTION

Specific details of several embodiments of portable stoves, and associated systems and methods, are described below. A person skilled in the relevant art will recognize that suitable stages of the methods described herein for making a heating device or portable stove can be performed using various equipment, materials, and design parameters as desired, as well as such constructing components in a manner to be easily assembled or disassembled by a user. Furthermore, unless the context indicates otherwise, structures disclosed herein can be formed using conventional equipment and/or fabrication techniques for building stoves, heaters, or other heating devices.

In this disclosure, numerous specific details are discussed to provide a thorough and enabling description for embodiments of the present disclosure. One of ordinary skill in the art will recognize that the disclosure can be practiced without one or more of the specific details. Well-known structures and/or operations often associated with portable stoves may not be shown and/or may not be described in detail to avoid obscuring other aspects of the disclosure. In general, it should be understood that various other devices, systems, and/or methods in addition to those specific embodiments disclosed herein may be within the scope of the present disclosure.

The term “heating device” can refer to an assembly of one or more components, chambers, containers, plates, sliders, trays, racks, tubes, pipes, vents, exhausts, and/or manifolds, which may include interposers, supports, fixtures, and/or other suitable materials. The heating device may be manufactured as, but not limited to, as a unitary portable device, a collapsible, foldable, or otherwise dismantlable device, and/or modular or compartmentalizable device. A heating device can include, for example, a fuel source, a heating mechanism, one or more spaces, compartments, or chambers, and one or more openings, vents, fans, heatsinks or exhausts. A heating device may further include non-planar surfaces, regular and irregular (e.g., non-polygonal) apertures, and removeable or moveable partitions within the one or more spaces, compartments, or chambers. A heating device may refer herein to a stove or a portable stove, but heating devices are not so limited.

The term “portable stove” can refer to an arrangement with one or more heating devices, systems, or mechanism incorporated into an enclosure or housing. The portable stove can include a housing or casing that partially or completely encloses at least one heating device, system, or mechanism.

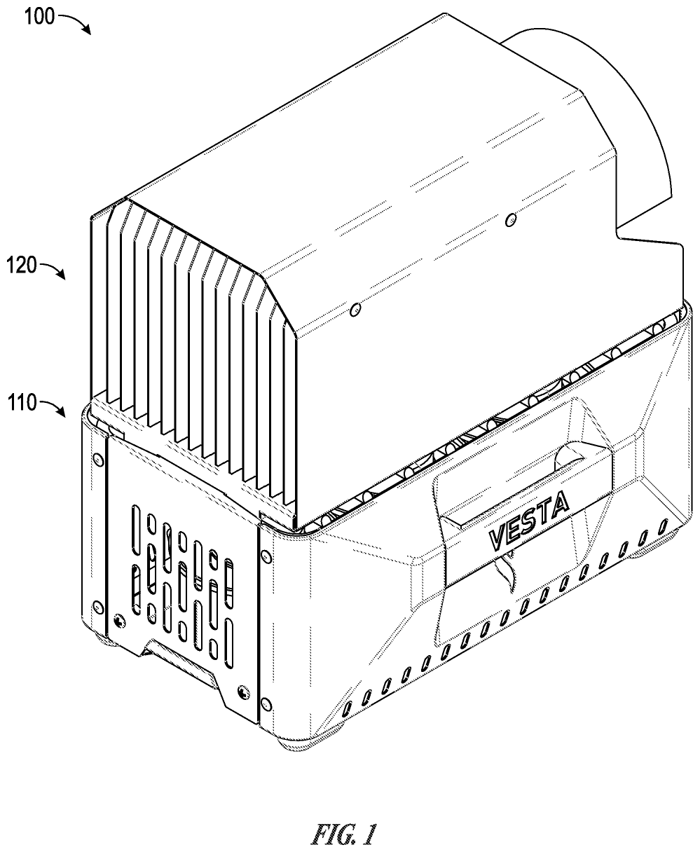

FIG. 1 is a simplified perspective view of a combination stove and space heater 100 in accordance with one embodiment of the present disclosure. The combination stove and space heater 100 includes a lower stove portion 110 and a removable upper heater portion 120. The lower stove portion 110, with the upper heater portion 120 removed, permits cooking (e.g., on a cooking surface such as a grill or griddle) with a variety of burnable fuel sources (e.g., canned liquid fuel, wood, charcoal, other biomass, etc.) in a conveniently portable form factor. The upper heating portion 120, when combined with the lower stove portion 110, permits the same fuel sources to be used for areal heating (e.g., of a living enclosure, or a region surrounding the unit while out-of-doors).

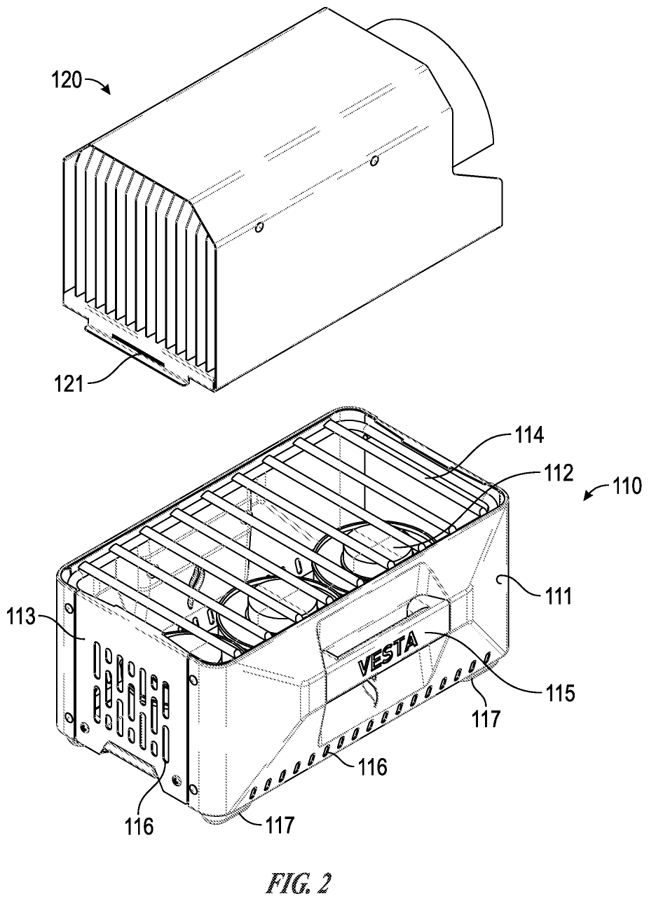

Turning to FIG. 2, which provides a simplified perspective view of the upper heating portion 120 and the lower stove portion 110 in accordance with one embodiment of the present disclosure after their mutual separation, additional details of both can be more readily appreciated. The lower stove portion 110 includes an enclosure 111 in which one or more burnable fuels 112 can be disposed (e.g., through a door or drawer, such as drawer 113). Suspended over the burnable fuels 112 is a removable cooking surface, such as grating 114, which may be suspended at a fixed height relative to the enclosure, of may alternatively permit for height adjustments to better control cooking temperature. The enclosure 111 may include one or more handles 115 (e.g., on opposing side surfaces thereof) to permit the easy transport of the lower stove portion 110, even while combustion is occurring (e.g., by providing insulated or non-thermally conductive handles 115). The enclosure 111 may further include a variety of through-penetrations 116 in the side and/or lower surfaces thereof (e.g., when the lower surface is elevated above the ground by one or more feet, such as feet 117) to permit the flow of air into the enclosure 111 to support combustion of the one or more burnable fuels 112.

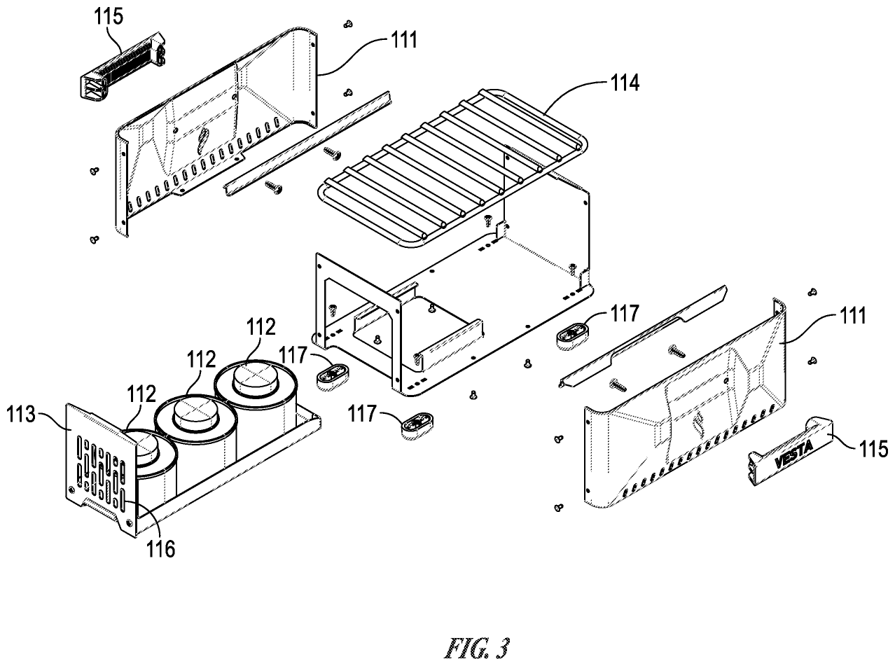

Turning to FIG. 3, in which a simplified exploded partial perspective view of the lower stove portion 110 is provided in accordance with an embodiment of the present disclosure, still more details may be even more easily appreciated. As can be seen with reference to FIG. 3, the drawer 113 can be laterally translatable into and out of the enclosure 111, which in turn may comprise a frame 111a and a plurality of sidewalls 111b. Each sidewall 111b may have a separate handle 115 thereon, formed from a thermally non-conductive material (e.g., plastic). Still other arrangements (e.g., different numbers and/or configurations of handles, sidewalls, drawer rails, feet, etc.), even though not specifically illustrated, will be readily appreciated by those skilled in the art.

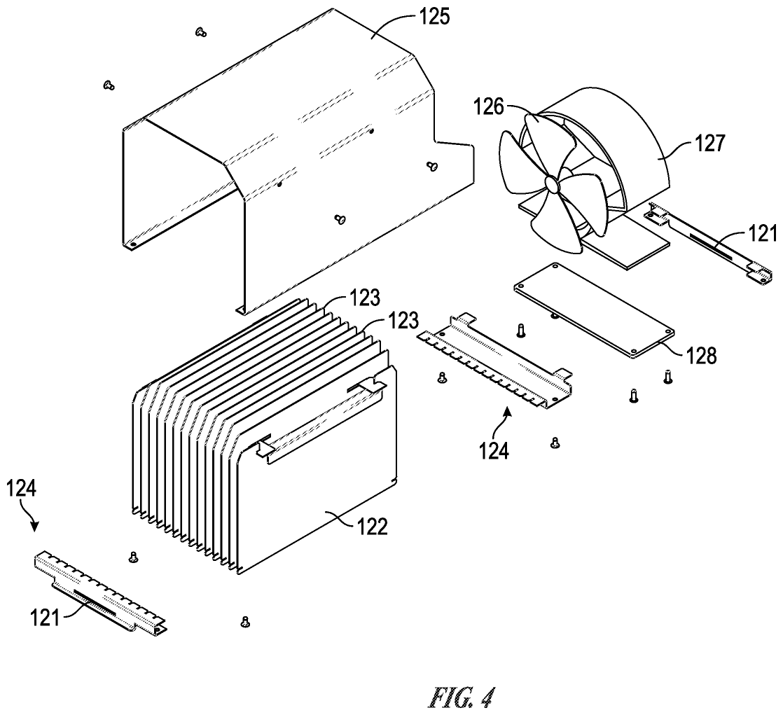

Similarly, FIG. 4 provides a simplified exploded partial perspective view of the upper heater portion 120 according to one aspect of the present disclosure, in which additional details of the configuration thereof can be readily appreciated. As can be seen with reference to FIG. 4, the upper heater portion 120 can include one or more latches 121 or other similar mechanisms configured to permit secure fixation of the upper heater portion 120 to the lower stove portion 110 (e.g., during operation in heater mode or during transport). The upper heater portion 120 can further include a radiator 122 formed from a plurality of substantially-parallel vertical plates 123, held in fixed relation to one another by spacers 124 on either side thereof and/or passing therethrough. The vertical plates 123 are aligned along a longitudinal axis of the upper heater portion 120, to permit the flow of air between the vertical plates along that longitudinal axis. The upper heater portion may further include a removeable cover 125 that surrounds the vertical plates, and is open at opposing ends along the longitudinal axis to constrain airflow along the longitudinal axis.

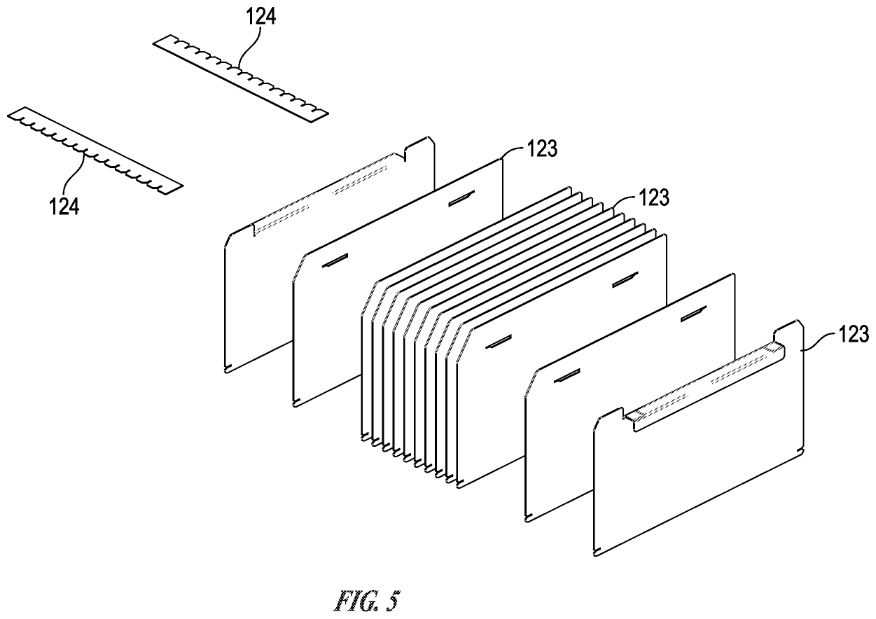

The upper heater 120 can further include an axial fan 126 (e.g., as part of a fan assembly 127) that is mounted on a plate 128. The plate 128 can be mounted to the spacer 124 at one end of the plurality of vertical plates, so that the axial fan 126 can be configured to flow air between the vertical plates 123 to facilitate heat exchange between the radiator 122 and the air surrounding the combination stove and space heater 100. This may be more readily appreciated with reference to FIG. 5, in which a simplified exploded partial perspective view of the radiator 122 is illustrated in accordance with one aspect of the present disclosure. As can be seen with reference to FIG. 5, the vertical plates 123 may have different heights and or plan dimensions to accommodate a cover 125 with beveled or rounded corners. Moreover, additional spacers 124 that pass through openings in the vertical plates 123 can be provided to maintain a fixed spacing relationship between the vertical plates 123.

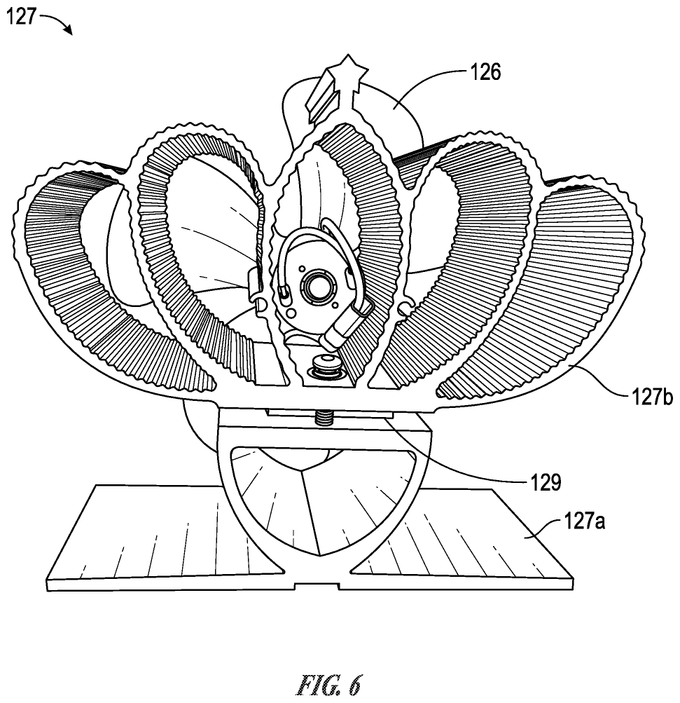

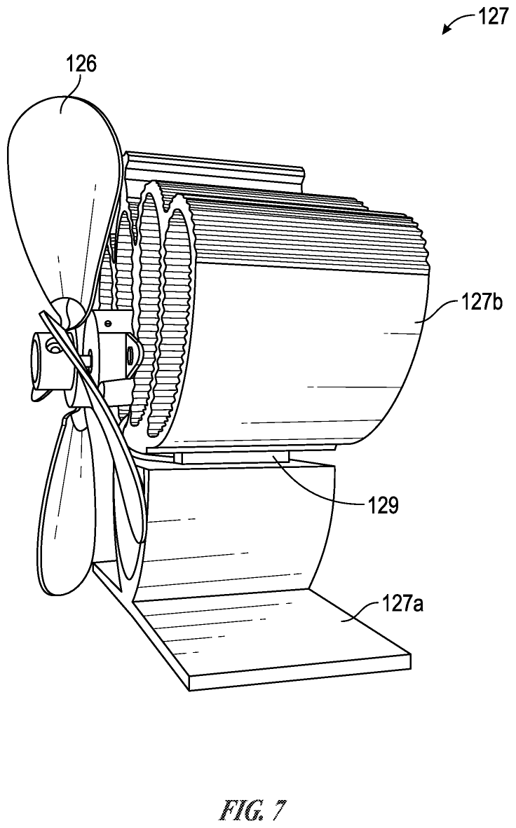

Turning to FIGS. 6 and 7, in which two different simplified partial perspective views of a fan assembly of an exemplary combination stove and space heater are illustrated in accordance with one embodiment of the present disclosure, additional details regarding the configuration of the fan assembly can be more easily understood. Fan assembly 127 includes an axial fan 126 (e.g., comprising an electric motor turning a shaft to which fan blade(s) are secured) and a thermo-electric generator (TEG) 129 sandwiched between lower and upper heatsink portions (127a and 127b, respectively). As will be readily understood by one of skill in the art, by relatively heating one surface of the TEG 129 (e.g., by increased exposure to the heat of combustion in the lower stove portion 110 through the plate 128) while relatively cooling the other surface (e.g., by increased distance from the heat of combustion, the cooling effect of the radiative structures of the upper heatsink portion 127b, and/or the cooling effect of the airflow generated by the axial fan 126), an electric potential can be generated by the TEG 129. In this regard, the electric potential generated by the differential in temperature across the TEG 129 can be provided to the fan 126 by (e.g., heat-resistant) wiring, causing the fan to generate an airflow over the heat exchanging structures of the upper heatsink portion 127b (thereby maintaining or contributing to a temperature differential across the TEG) and over the vertical parallel plates 123 of the radiator 122 (thereby facilitating heat exchange between the radiator 122 and the environmental air).

In accordance with another aspect of the present disclosure, the fan 126 could alternatively or additionally be coupled to other sources of electric power, such as removeable or rechargeable batteries. Moreover, although the foregoing examplary embodiments have been illustrated and described as including a single axial fan 126 at one end of the radiator 122, in other embodiments different numbers and/or kinds of fans could be used in lieu of or addition to a single axial fan (e.g., one or more centrifugal fans).

The devices, systems and functions described herein may be implemented in interior and exterior heating devices, stoves, and other portable devices used to heat, cook, or warm food items. Other examples and implementations are within the scope of the disclosure and appended claims. Features implementing these devices, systems and functions may also be physically located at various positions, including being distributed such that portions of these devices, systems and functions are implemented at different physical locations.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, the terms “vertical,” “lateral,” “upper,” “lower,” “above,” and “below” can refer to relative directions or positions of features in the devices in view of the orientation shown in the Figures. For example, “upper” or “uppermost” can refer to a feature positioned closer to the top of a page than another feature. These terms, however, should be construed broadly to include devices having other orientations, such as inverted or inclined orientations where top/bottom, over/under, above/below, up/down, and left/right can be interchanged depending on the orientation.

It should be noted that the methods described above describe possible implementations, and that the operations and the steps may be rearranged or otherwise modified and that other implementations are possible. Furthermore, embodiments from two or more of the methods may be combined.

From the foregoing, it will be appreciated that specific embodiments of the present disclosure have been described herein for purposes of illustration, but that various modifications may be made without deviating from the scope of the present disclosure. Rather, in the foregoing description, numerous specific details are discussed to provide a thorough and enabling description for embodiments of the present disclosure. One skilled in the relevant art, however, will recognize that the disclosure can be practiced without one or more of the specific details. In other instances, well-known structures or operations often associated with memory systems and devices are not shown, or are not described in detail, to avoid obscuring other aspects of the present disclosure. In general, it should be understood that various other devices, systems, and methods in addition to those specific embodiments disclosed herein may be within the scope of the present disclosure.

What is claimed is:

1. A combination stove and space heater, comprising:
a stove portion, including:
an enclosure having a removable drawer configured to receive one or more burnable fuels, and
a grating suspended by the enclosure over the removable drawer and configured to be heated by burning the one or more fuels; and
a removable heater portion disposed over the stove portion, the removable heater portion including:
a radiator having a plurality of vertical plates, each having a length along a lateral axis and a height along a vertical axis,
an axial fan disposed at one side of the radiator and with an axis of flow substantially parallel to the lateral axis, and
a cover disposed surrounding the radiator and the axial fan, the cover having openings on opposing ends along the lateral axis.

2. The combination stove and space heater of claim 1, wherein the axial fan is electrically coupled to a battery holder.

3. The combination stove and space heater of claim 1, wherein axial fan is configured flow air from outside the heater portion across the vertical plates of the radiator.

4. The combination stove and space heater of claim 1, further comprising a thermo electric generator (TEG) configured to generate a current when the one or more fuels are burned, the TEG being electrically coupled to the axial fan.

5. The combination stove and space heater of claim 4, wherein the TEG includes a cold side coupled to heat exchange fins cooled by air flowed by the axial fan and a hot side coupled to a hot plate disposed between the axial fan and the one or more burnable fuels.

6. The combination stove and space heater of claim 1, wherein the enclosure of the stove portion includes at least one carrying handle on at least one side surface thereof.

7. The combination stove and space heater of claim 1, wherein the removable drawer is translatable along the lateral axis.

8. The combination stove and space heater of claim 1, wherein the one or more burnable fuels comprise canned liquid fuel, wood, or charcoal.

9. A combination stove and space heater, comprising:
a stove portion, including:
an enclosure having a removable drawer configured to receive one or more burnable fuels, and
a cooking surface suspended by the enclosure over the removable drawer and configured to be heated by burning the one or more fuels; and
a removable heater portion coupled to the stove portion, the removable heater portion including:
a radiator having a plurality of vertical plates, each having a length along a lateral axis and a height along a vertical axis, and
an axial fan disposed at one side of the radiator and with an axis of flow substantially parallel to the lateral axis, wherein axial fan is configured flow air from outside the heater portion across the vertical plates of the radiator.

10. The combination stove and space heater of claim 9, wherein the axial fan is configured to be electrically powered by one or more batteries.

11. The combination stove and space heater of claim 9, further comprising a cover disposed surrounding the radiator, the cover having openings on opposing ends along the lateral axis.

12. The combination stove and space heater of claim 9, further comprising a thermo electric generator (TEG) configured to generate a current when the one or more fuels are burned, the TEG being electrically coupled to the axial fan.

13. The combination stove and space heater of claim 12, wherein the TEG includes a cold side coupled to heat exchange fins cooled by air flowed by the axial fan and a hot side coupled to a hot plate disposed between the axial fan and the one or more burnable fuels.

14. The combination stove and space heater of claim 9, wherein the enclosure of the stove portion includes at least one carrying handle on at least one side surface thereof.

15. The combination stove and space heater of claim 9, wherein the removable drawer is translatable along the lateral axis.

16. The combination stove and space heater of claim 9, wherein the one or more burnable fuels comprise canned liquid fuel, wood, or charcoal.

17. A combination stove and space heater, comprising:
a stove portion, including:
an enclosure having a removable drawer configured to receive one or more burnable fuels, and
a cooking grate suspended by the enclosure over the removable drawer and configured to be heated by burning the one or more fuels; and
a removable heater portion coupled to the stove portion, the removable heater portion including:
a radiator having a plurality of vertical plates, each having a length along a lateral axis and a height along a vertical axis, and
a cover disposed surrounding the radiator, the cover having openings on opposing ends along the lateral axis.

18. The combination stove and space heater of claim 17, further comprising an axial fan disposed at one side of the radiator and with an axis of flow parallel to the lateral axis, wherein axial fan is configured flow air from outside the heater portion across the vertical plates of the radiator.

19. The combination stove and space heater of claim 17, wherein the enclosure of the stove portion includes carrying handles on opposing side surfaces thereof.

20. The combination stove and space heater of claim 17, wherein the one or more burnable fuels comprise canned liquid fuel, wood, or charcoal.
